(19) United States
(12) Patent Application Publication
(10) Pub. No.: US 2002/0038233 A1
(43) Pub. Date: Mar. 28, 2002

(54) System and method for matching professional service providers with consumers

(76) Inventors: Dmitry Shubov, San Francisco, CA (US); Anna Ostrovsky, Berkeley, CA (US)

Correspondence Address: Paul K. Tomita, Dergosits & Noah LLP, Four Embarcadero Center, Suite 1150, San Francisco, CA, 94111, US

(21) Appl. No.: 09/876,390

(22) Filed: Jun. 6, 2001

Related U.S. Application Data
(60) Provisional application No. 60/210,857, filed on Jun. 9, 2000.

(51) Int. Cl. G06F 17/60

(52) U.S. Cl. 705/8

(57) ABSTRACT

A system for matching consumers with service providers via a matching system that uses computers connected to a server through a network. A consumer is asked a series of preselected questions about his or her service needs. The consumer can answer the questions by clicking on an appropriate answer that is listed under the questions. Alternatively the consumer may type in a text answer. The matching system cross references the consumer answers with a database of service providers. The matching system posts a description of the case which is available to all service providers and forwards a description of the case to service providers that are qualified to perform the desired services. The service providers can submitting bids which are returned to the consumer. The consumer can view and compare all bids and obtain additional information about each service provider through the consumer homepage before selecting a service provider for the work. After the services are complete, the consumer can rate the service provider and the rating will be available to other consumers.

### CROSS-REFERENCE TO RELATED APPLICATIONS

Priority of U.S. Provisional Patent Application Ser. No. 60/210,857, filed Jun. 9, 2000, incorporated herein by reference is hereby claimed.

### BACKGROUND

The process of obtaining consumers for professional service providers is a frequently complex process that involves several steps. Consumers are informed about professional service providers through marketing, community reputation, and word of mouth. After finding a service provider, the consumer must then call and/or meet with the professional service provider. The consumer explains the type of services needed and the service provider provides an estimate or quote for the services. The consumer then either chooses the service provider or alternatively the consumer can call or meet with other service providers.

Because the process of matching service providers with consumers is complex, various products have been developed to assist in matching consumers and service providers. Telephone directories have listings of professional service providers that allow consumers to search for local service providers. Similarly, professional service directories are published with listings of members which consumers may also browse through. Still other referral services exist where a consumer can call a number and be referred to a service provider in the area. With the development of the internet, many of these professional service directories are now available on web sites which allow consumers to browse through electronic web pages rather than directory pages. Although these web sites provide a more easily accessible source of information, they typically only provide basic information about the service providers such as phone numbers, street addresses, links to the service provider's web site and in some cases a means of communication between the service provider and consumer.

Some web sites have developed that provide bidding for specific types of professional services. For example, Sharktank and CaseMatch are systems that receive requests for legal services and then notifies member attorneys by e-mail about potential cases together with anonymous consumer contact information. Typically the attorney and consumer can communicate via an anonymous e-mail address. If a lawyer wants a particular case, he or she contacts the consumer through the anonymous e-mail address and recommends legal action and provides a proposed fee. Other systems such as B4Blaw, and US Law have web sites that have listings of lawyers. A consumer can anonymously browse through the listings of all member lawyers on the web site or search for an attorney by area of practice and geographic location. If the consumer is interested in obtaining a quote for legal services, he or she can contact the lawyer via means outside the website.

BizBuyer and Bsource are web sites that allow consumers to post requests for professional services. Service providers can browse through the posted requests and return bids for the services to the consumers. These sites provide a communications channel between service providers and consumers.

Other systems such as eLance and eWanted are not limited to legal services and allow consumers to post a description of their service needs which can be viewed by service providers logged onto their web sites. Service providers can communicate an offer on the project to the consumer and based upon the offers, the consumer can select a service provider through the web site. After the consumer selects a service provider for a project, consumer contact information is released to the service provider so that the parties can more easily communicate and the project can be completed.

Although the prior art service matching systems utilize the internet, none of these services provides a method for automatically forwarding consumer cases to service providers by searching through a database and finding service providers who can perform the required services and are located in the same area as the consumer.

### SUMMARY OF THE INVENTION

The inventive matching system is an integrated system which assists in matching the consumers with professional service providers. The matching system coordinates communications between consumers and qualified service providers located in the same region as the consumer. The matching system is computer based and includes: a network, a service provider database, a consumer database and a software program for searching the databases and coordinating communications between consumers and service providers.

Consumers can access the matching system via a network through a consumer graphical user interface (GUI) which is displayed on a computer as a home page. Each consumer has his or her own secure homepage. After logging on, a consumer can access various matching system features and service provider information through the homepage. The consumer can browse through a listing of all service providers and view more detailed information by clicking on buttons for: contact information, specific services provided, former consumer ratings, education, and other pertinent information. A consumer can also request bids for services from service providers by posting a case.

When the consumer selects the post a case function, the consumer home page displays a series of questions on interactive screens that allows consumers to quickly describe his or her service needs and geographic location via the home page. The matching system allows the consumer to quickly and easily describe the requested services through interactive screens that query the consumer about the case. The consumer can respond to the questions by pointing and clicking on the appropriate answers listed with a computer mouse. After the consumer answers a question about the requested service, the matching system may display more detailed questions about the service. The matching system also allows consumers to write a description of the service needs. After the questions have been answered the consumer can recheck the answers and then post the case to the matching system. The matching system stores the specific information about the consumer's requested services and geographic location in the consumer's account on the consumer database. The matching system posts the case to make it available to all service providers and also transmits the case information to service providers who perform the requested service and are located in the same area as the consumer. The consumer can view and modify a posted case through the consumer homepage.

The matching system only transmits consumer information to service providers in the same area of practice and same geographic location by cross referencing the consumer's case information with the service provided and geographic location fields of the service provider database. The consumer's case is then forwarded to select service providers based upon the type of service and location. Alternatively, the consumer can request that the case information be sent to service providers having special skill such as: specific language abilities, specific level of experience, education level, or any other factor that the consumer may consider to be important.

Each service provider has his or her own secure home page. After logging onto the matching system, the service provider can access their own account and review all cases that have been routed them by the matching system. After reviewing a case, the service provider can respond to any cases that he or she is interested in pursuing. The response can include: contact information, a link to the service provider's profile, a bid on the services, a recommendation of the services to be provided and any other relevant information. Responses from service providers are transmitted back to the consumer. The service provider can modify the response to a case and track the status of a case through the service provider home page.

The consumer can review all service provider responses through the consumer home page. The consumer can also obtain additional information about the service provider such as: education, experience, associations, office location, special offers and rating information through the consumer homepage. The rating information includes ratings and assessments of the service provider's work from consumers. Based upon the information provided by the matching system, consumers can make an informed decision in selecting a service provider. The accessibility to information about the service providers makes the matching system much more informative than service provider listing systems. In an embodiment, the matching system can control the order and posting of responses by service providers on the consumer home page. This allows the matching system to give priority to select service providers which can result in obtaining more cases.

In an exemplary system, the matching system is configured to match attorneys to consumers. A consumer accesses the matching system through the consumer homepage interface and selects the post a case function. The matching system responds by asking the consumer a series of questions that allow the user to quickly describe the case by clicking on various descriptors. The matching system may first ask the consumer what primary category of law the case involves and list a series of simplified answers. Much of the public may not understand legal terminology, thus simplified case descriptions allows more people to describe their case. The consumer can click on an answer and in response, the matching system asks the consumer to describe a secondary category of law. If the consumer selects the basic type of law as injury, the matching system may ask additional intake questions related to injury cases. Each question has a listing of possible answers that the consumer can click on. Alternatively, if the answer is not listed, the consumer can enter a text answer. After all information about the case has been input into the matching system, the answers are stored on the consumer database. The consumer can review and modify the answers before the case is posted to attorneys.

Once the consumer posts the case, the matching system cross references the consumer's answers with the attorney database to find attorneys who practice injury law and are in the same area as the consumer. Posted cases may be viewable by all attorneys through the matching system. In an embodiment, the consumer can select which attorney attributes to cross reference with the case.

Attorneys who matched the cross referenced attributes receive a description of the case. The case description may not include the consumer's identity to insure case confidentiality. When an attorney receives a case, the attorney can review the cases and send an offer to the consumer, request additional information or delete the case. When the attorney chooses to place an offer on a case, the matching system assists in creating a response. The matching system may also ask the attorney a series of question with a corresponding list of answers that the attorney can click upon and the attorney can add his or her own text messages to the offer. The complete offer will include recommended legal actions, a bid for the legal services, attorney profile and contact information, the selected answers to the matching system questions, ratings from former clients and any additional text messages. The attorney can if necessary modify the response and retransmit the offer to the consumer.

The completed offers from attorneys are returned to the consumer. The consumer can view additional information about the attorney who placed offers and the matching system can also track which attorney information the consumer has viewed. As discussed, the response includes: a specific bid, links to additional information about the attorney and ratings from former consumers. With the information provided by the matching system, an informed decision can be made when selecting an attorney.

Through the matching system, the attorney can review the status of all pending or expired cases in their accounts. The case status information may include: bid acceptance, bid rejection, winning bid information, and revocation of case by the consumer or under certain circumstances the matching system administrator. If the attorney's bid has been accepted by the consumer, notification will be made through the system and additional case information is transmitted which may include the identification of the consumer is revealed. In an embodiment, the consumer is anonymous during the service bidding process and the identity of the consumer can only be released by the consumer.

When the consumer accepts the terms of a bid, the consumer may contact the service provider to form a binding for legal services contract outside the matching system. Alternatively, a contract may be formed through the matching system with electronic signatures by both parties. After the contract is signed, the legal services are performed. If the consumer's acceptance of a bid is done through the matching system, the consumer/attorney match can be tracked.

If the consumer is pleased with the attorney's work, the consumer can utilize the services of the attorney in the future for similar cases. A consumer can also post a rating of the attorney on the matching system. The rating may be based upon various factors including: quality of work, award or settlement terms, competence, etc. These ratings are stored on the attorney database and can be viewed by other consumers to assist with their attorney selection process. In an embodiment, the matching system can contact the consumer after a specific period of time through the consumer web page and ask the consumer questions to rate the attorney.

### BRIEF DESCRIPTION OF THE DRAWINGS

The invention is herein described, by way of example only, with reference to embodiments of the present invention illustrated in the accompanying drawings, wherein:

FIG. 1 is a block diagram of exemplary matching system hardware components;

FIG. 2 is a block diagram of the matching system configured to match attorneys with consumers;

FIG. 3 is a flow chart of functions accessible through the consumer home page;

FIG. 4 is a flowchart of an embodiment of the post a case function;

FIG. 5 is a flowchart of functions accessible through the attorney home page; and

FIG. 6 is a flowchart of the make n offer function.

### DETAILED DESCRIPTION

The present invention addresses the above and other problems associated with systems for matching service providers with consumers. Aspects of the present invention may be implemented on one or more computers each executing software instructions. The steps of controlling devices, accessing, downloading, and manipulating data, as well as other aspects of the present invention are implemented by a central processing unit (CPU) in computers which execute sequences of instructions stored in a memory. The memory may be a random access memory (RAM), read-only memory (ROM), a persistent store, such as a mass storage device, or any combination of these devices. Execution of the sequences of instructions causes the CPU to perform steps according to embodiments of the present invention.

According to one embodiment of the present invention, a server computer system transmits and receives data over a computer network or standard telephone line. Data may be loaded into the memory of the server computer from a storage device, or from one or more other computer systems over a network connection. For example, a consumer computer may transmit a sequence of instructions to the server computer in response to a message transmitted to the consumer over a network by the server. As the server receives the instructions over the network connection, the instructions are stored in the server's memory. The server may store the instructions for later execution, or it may execute the instructions as they arrive over the network connection. In some cases, the CPU may directly support the downloaded instructions. In other cases, the instructions may not be directly executable by the CPU, and may instead be executed by an interpreter that interprets the instructions. In other embodiments, hardwired circuitry may be used in place of, or in combination with, software instructions to implement the present invention. Thus, the present invention is not limited to any specific combination of hardware circuitry and software, or to any particular source for the instructions executed by the server or consumer computers.

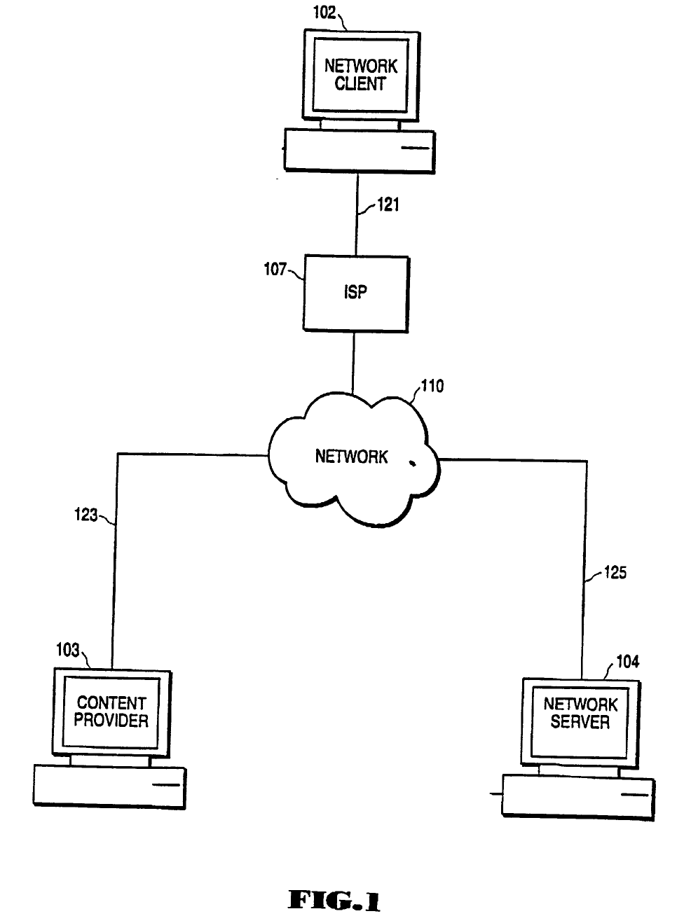

FIG. 1 is a block diagram of the matching system hardware components. The network server 104 runs the matching system software and controls the attorney and consumer databases on mass storage devices. The network server is connected to other computers 102 (consumer and attorney) via a network which may be the Internet, a Wide Area Network (WAN), a Local Area Network (LAN), or any combination thereof. The computers are connected to the network through an information service provider 107. Various types of connections between the computers 102 and service providers 107 including: telephone wires (dial up modems, DSL), cable, wireless, T1, or any other type of connection.

In one embodiment of the present invention, the server computer 104 is a World-Wide Web (WWW) server that stores data in the form of ‘web pages’ and transmits these pages as Hypertext Markup Language (HTML) files over the Internet network 110 to one or more of the computers 102. The computers 102 typically run a “web browser” program to access the web pages served by server computer 104 that allows a user to access and view web pages provided by the web server 104. During a typical web browsing operation, a user on a computer 102 accesses a web page from the server computer 104 by typing or entering the URL corresponding to the server web site in the address field of his or her web browser.

In one embodiment of the present invention, wherein network 110 is the Internet, network server 104 also executes a web server process (not shown to avoid obscuring the illustration) to provide HTML (or XML or similarly coded) documents to client computers coupled to network 110. To access the HTML files provided by server 104, client computer 102 runs a web client process (typically a web browser, such as Netscape Navigator or Microsoft Explorer) that accesses and provides links to web pages available on server 104 and other Internet server sites. It should be noted that a network system 100 that implements an embodiment of the present invention may include a larger number of interconnected client and server computers than shown in FIG. 1.

As can be appreciated by those of ordinary skill in the art, the representative networked computers of FIG. 1, such as network server computer 104 can be implemented as any standard computer that includes a CPU coupled through a bus to other various devices. These devices could include random access memory (RAM), a read only memory (ROM), and mass storage devices (e.g., a magnetic disk, optical compact disk, or tape drive for storing data and instructions). The computer also typically includes input/output devices, such as, a display device, keyboard, and network interface device, along with other similar devices or interfaces. Any of the computers in FIG. 1 could be implemented in the form of personal computers, laptop computers, mainframe computers, or other type of workstation computers.

The matching system runs on the described computer system and provides a more efficient means of matching consumers with service providers. The following description is an embodiment of the matching system for matching consumers with attorneys for legal services. It is contemplated that the described matching system can easily be modify to professional services other than legal services.

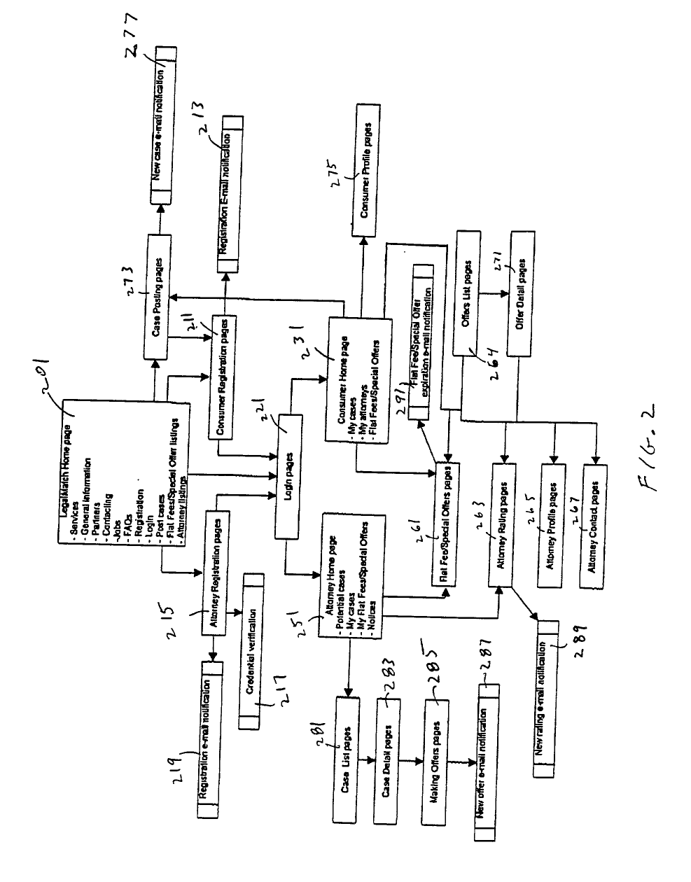

FIG. 2, illustrates an block diagram of an embodiment of the matching system which matches consumers with attorneys. As discussed, the matching system is accessed through a computer connected to a network. By going to the matching service address on the network, a matching system home page 201 is displayed. The matching system home page 201 has descriptive information about the matching system and buttons that allow users to register and log onto the matching system. Users can also click on buttons to access additional information about the matching system organization, services provided by the matching system, general information, partners, contact information, jobs, frequently asked questions, case posting, flat fees/special offers, and attorney listings.

To ensure security from unauthorized access and use of the matching system, which has software that is configured such that only properly authorized personnel are allowed access. In order to have any access to matching system functions, all consumers and attorneys must first register. The consumer and attorney registration requires the submission of an e-mail address, unique user name, password, password confirmation question and answer to used to retrieve a forgotten password, and e-mail notification preferences. The registration information is stored on the matching system database.

Before a consumer can post a case on the matching system, he or she may go to the consumer registration section 211 to enter basic consumer information. The consumer may need to provide an e-mail address in order to receive a password. After the consumer submits the required registration information, the matching system sends an e-mail 213 that confirms registration and notifies the consumer that he or she is now allowed access to the consumer's personalized homepage and certain matching system services.

Similarly, before an attorney can use the matching system, he or she must go through attorney registration section 215. In order to register the attorney may be required to provide: an e-mail address, the state(s) in which the attorney is licensed to practice, the attorney's bar number(s), a log on name and a password. After the required attorney registration information is submitted, attorney's state bar license, identification and credentials may be verified 217 by the matching system administrators or electronically with the state bar associations. If the identification and credentials of the attorney are verified 217, the matching system may transmit registration confirmation via e-mail 219 to the attorney. If there are anomalies with the credentials of the attorney, the matching system will notify the attorney of the problem and provide a course of action to correct the problem.

The consumers and attorneys both have log on names which allow them to communicate anonymously within the matching system. The identification number also allows the matching system to track the consumer's and the attorney's use of the matching system. Specifically, the matching system can track the location of the consumer or attorney within the matching system. Attorneys are interested in exposure to consumers. The matching system can track which consumers access which attorney information and quantify the exposure of information to consumers. This quantified exposure information can be used to billing attorneys for viewing their posted information on the matching system.

After registration, both consumers and attorneys access the matching system through the log in section 221. The consumer or attorney submits their personalized password and the matching system verifies the password. The matching system responds to the password by displaying either the consumer home page 231 or attorney home page 251. Each home page is personalized to the user and includes information specifically associated with the user's password.

The user can create a profile from their homepages which includes the consumer's name or company name, mailing address, phone numbers and fax number. The attorney profile includes: name, address, phone numbers, fax number, states of practice, certifications, publications, honors and awards, memberships, additional language skills, prior legal employment, representative consumers, specific experience, law school information, undergraduate information, other education, areas of practice and any additional information that the attorney wishes to provide. In order to avoid misrepresentation, the attorney's profile information may be verified for accuracy before it is made available to other matching system users. In particular the areas of practice and the location information are used by the matching system to cross reference consumer cases.

The matching system may allow different levels of access for consumers and attorneys. Consumers have access to their own information, bids on their cases and information while attorneys will not have access to the consumers personal information or the personal information of other attorneys. In an embodiment, the consumer may input all information regarding a case through a consumer homepage but will not be able to post the case without registering.

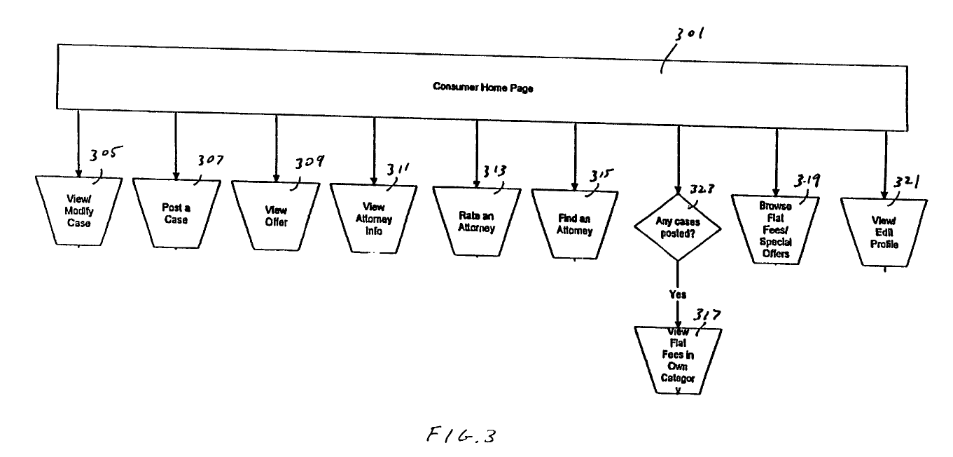

From the consumer home page 231 the registered consumer can access posted cases and the attorneys working the consumer's cases. In an embodiment, the consumer can access the current status of the case and communicate with the attorney working on the case electronically through the matching system. From the consumer home page, the consumer can also click on functional buttons to access additional information including: flat fee/special offers 261, attorney ratings 263, attorney profiles 265, attorney contact information 267, case offers 269, offer details 271, consumer profile 275 and case posting 273. If the consumer posts an attorney rating 263, the matching system will notify the attorney via e-mail 289 that a rating has been posted. Additional details of the consumer home page are discussed below with reference to FIG. 3.

In an embodiment, the case posting function may be accessed from both the matching system homepage 201 as well as the consumer home page 231. If the consumer goes to case posting 273 from the matching system homepage 201, the consumer must register 211 before the case is processed by the matching system. If the consumer does not register, the case posting information may be stored temporarily to allow the consumer to register and then deleted after a predetermined period of time. The matching system provides new case e-mail notification 277 that confirms consumer's case posting

From the attorney home page 251 the registered attorney can: view potential cases in selected categories, view potential cases in all categories, view new potential cases, modify profile, view own cases, modify contact information, view other offers, view attorney listings, view other new offers, view/modify my offer, View/modify my flat fee/special offers, post offer, and post a flat fee/special offer. In the create a profile section, the attorney can submit information that describes his or her qualifications, area of practice and location. The area of practice information and location information can be cross reference information that is used by the matching system to match cases with attorneys.

Potential cases are all cases that have been posted on the matching system. Potential cases in As discussed, cases are forwarded to attorneys after the cross reference process wherein the attorney provides services that match the consumer's case and the attorney's practice is in the same general area as the consumer. The attorney can click a case list button to view potential case listings pages 281. From the potential case listings page 281 the attorney can click on individual cases to view case detail pages 283. If the attorney wishes to bid on a potential case the attorney access the making offers 285 function and prepare a response to the consumers request for bid. The matching system confirms the attorney's response with e-mail notification 287.

In an embodiment, the attorney is notified about new potential cases via e-mail. The e-mails are preferably transmitted to each attorney only once per day with a complete listing of new cases, rather than transmitting a single case per e-mail as soon as each case is posted. By having a single e-mail the attorney can refer to a single document to quickly search for cases that he or she is interested in. The e-mail may have hotlinks to each of the cases so that if the attorney is interested in a case, details of the case can be viewed by clicking on the hotlinks.

The attorney can also access additional features from the attorney home page. The attorney can post special service fees on flat fee/special offers pages 261 which are viewable by consumer users. Typically these special service fees are only available for a limited time after which the special service fee offer is removed from the matching system. In an embodiment, the matching system will notify the attorney that the special service fee is about to expire 291 and ask if the attorney would like the duration of the offer to be extended.

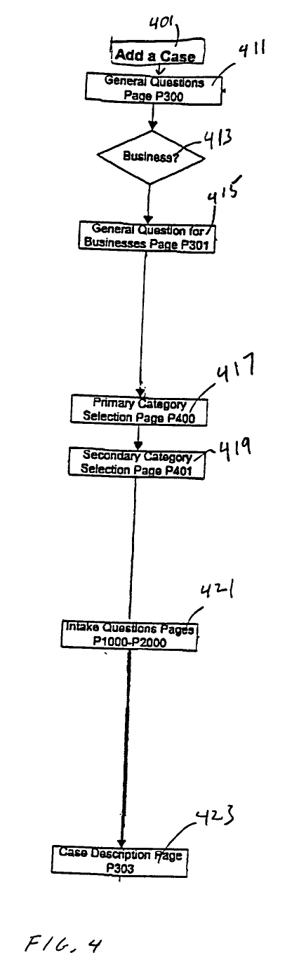

The attorney can also access the attorney rating information 263 which include consumer ratings of the member attorneys, the attorney profile information 265, and the attorney contact information 267. The attorney is notified 289 when a consumer posts a rating about the attorney. The attorney can post a statement in response to the consumer's rating. In an embodiment, the attorney can view his or her own ratings, however when viewing the ratings of other attorneys, the names of the other attorneys are concealed. More details of the attorney homepage are discussed below with reference to FIG. 4.

FIG. 3, illustrates a flow chart of accessible features from the consumer home page 301. From the consumer home page 301 the consumer can actuate various matching system functions by clicking on the appropriate button. The consumer can view or edit posted cases by clicking on the view/modify an existing case 305 button. The consumer can also check and revise the consumer profile by clicking on the view/edit consumer profile 321 button. The consumer can post a legal case by clicking on the post a case 307 button and answering a series of questions about the legal case (discussed in more detail below with reference to FIG. 4). After a case is posted, the matching system will automatically display flat fees/special offers in the category of the case posted 317. The consumer can view offers for legal services for the client's posted case by clicking on the view offer 309 button. The attorneys can make offers for flat fees or special offers that are posted on the matching system which consumers can view through the browse flat fees/special offers 319 function. If the consumer is interested in any of the flat fees or special offers, the consumer can obtain contact information and directly contact the attorney who posted the offer.

The find an attorney 315 function allows consumers to search the attorney database. In an embodiment, the consumer can submits attorney information such as: name, area of practice, and/or location and the matching system returns a listing of attorneys who match the search terms. In addition to database field searching, the matching system may allow full text searching of the attorney database. The consumer can view additional information about the attorney using the view attorney information 311 function which may display the attorney profile which has more details about the attorney's practice that may not be part of the searchable fields including: education, experience, professional memberships, etc. After working with an attorney, the consumer can use the rate an attorney function 313 to rate the attorney's performance (described in more detail with reference to FIG. 7).

With reference to FIG. 4, the consumers can request bids for legal services from attorneys through the matching system by selecting the post a case function. When the post a case function is selected, the matching system asks the consumer general questions 411 that provides information about the case. The general questions may include:

Is the case for an individual or business?

Where is location legal assistance needed?

Was there was previous representation for the case?

If the consumer is a business, the matching system then asks additional business questions 415, including: What is the business type? (partnership, franchise, private corporation, etc.)?

What does the business do? (manufacturing, construction, retail, professional, high technology, education, food services, government, manufacturing, transportation, etc.)

Where is the company located?(citywide, statewide, multiple states, nationwide, or international)

The matching system then asks the consumer what is the primary category of legal assistance needed 417. The primary category is the general legal area of the case such as bankruptcy, business, criminal, intellectual property, personal injury, property, tax, etc. Based upon the answer to the primary category, the matching system may ask the consumer about the secondary category of the case. For example if the primary category involves business, the matching system the matching system will ask the consumer to more narrowly describe the case by asking the consumer to select a secondary category from a listing: Bars and Restaurants, Commercial Law and Contracts, Construction, Corporations, Partnerships and Sole Proprietorships, Insurance, Other, Tax and Unfair Competition. If the consumer selects the secondary category of Tax, the matching system may ask the consumer to describe the case in even more detail. For example does the case involve: corporate tax, estate and gift tax, income tax, international tax, property tax, etc. The selected answer is the narrow category.

An exemplary listing of primary categories, secondary categories and narrow categories is in Appendix A. The consumers input the primary categories, secondary categories and narrow categories during the post a case process. The attorney's area of practice is listed as the narrow category which is input by the attorney while creating the profile. As discussed, the matching system cross references the consumer's case information with attorney's area of practice. The consumer's case may be forwarded to all attorney's whose area of practice matches the primary category of the case. Alternatively, the consumer's case may be forwarded to attorney's whose area of practice matches the secondary or narrow categories.

Based upon the consumer's narrow case category answer, the matching system asks the consumer additional intake questions that more narrowly describe the case 421. For example if the narrow category is Business Income Tax, the matching system may ask the consumer the following intake questions:

1. My organization needs legal assistance in a tax matter for (Select all that apply)

Consultation

Tax Preparation

Audit

IRS hearing or trial Other [Text]

2. The tax assistance I need involves (Select all that apply)

Federal

State

Local

Other [Text]

3. My organization is (Select one)

Privately Held

Publicly Traded

Non For-Profit

4. My organization's tax election is (Select one)

S corporation

C corporation

I don't know

In another example, if the narrow category is Driving While Intoxicated, the matching system may ask the consumer the following intake questions:

1. The police officer said that he/she stopped me for (Check one)

Speeding

Weaving

Reckless Driving

Sobriety Checkpoint/Roadblock

Vehicle Non-compliance (no headlights, expired tags, etc.)

Accident

Other [Text]

2. There were other passengers in my vehicle who witnessed the incident.

Yes. Number of Passengers [scroll: 1-2-3-4 or more]

No

3. I was given the following tests to determine if I was intoxicated. (Check all that apply)

Field Sobriety Test (walking a straight line, balancing, reflexes, hand-eye coordination)

Breathalyzer

Blood or Urine Sample

Other [Text]

4. I asked the police officer to give me my sample from the Breathalyzer or blood test. (Check one)

Yes

No

5. The test showed a blood-alcohol level of (check one)

0.07 or less

0.08 to 0.09

0.10 to 0.15

0.16 to 0.20

0.21 or more

don't know

6. Following the police officer's examination, I was (Check one)

Cited and released

Arrested

Other [Text]

7. Following my arrest, the police officer (Check all that apply)

Failed to explain my rights

Continued to ask me questions even after I asked to speak to a lawyer

None of the above

Not arrested

8. The number of previous times I have been convicted or pled guilty of DWI/DUI is

[Pull Down]: none/1/2/3 or more

9. The incident occurred on the following date and time of the day

Date [00-00-00]

Time [Text] [pulldown: a.m./p.m.]

10. At the time of this incident, my driver's license was (Check one)

Valid

Suspended

Revoked

11. I believe that I was stopped because of my race

Yes. My race is [Pull Down]

African American/Black

Asian/Pacific Islander

Latino/Hispanic

Caucasian/White

Native American

Other

No.

Intake questions for other narrow categories of cases are in U.S. Provisional Patent Application Ser. No. 60/210,857, which is incorporated by reference.

The consumer can answer all questions by either clicking on an appropriate answer from a listing of answers or alternatively, the consumer may type in a text response to a question if the consumer's answer is not listed or additional details are needed. The lists of case description answers allows consumers to precisely describe their service needs without having to write out a description of their problem or task. By presenting the consumer with a series of preselected questions and answers, the consumer is forced to provide the information required to properly analyze the legal services needs before the case is forwarded to attorneys. The questions guide the consumer to the relevant issues to simplify and improve the accuracy of the case description.

After the category and intake questions are answered the case is posted and processed by the matching system. If the consumer does not know the answer to all of the questions, the case can still be posted with as much information as the consumer provide. If mistakes are made and/or changes are required, the case description can be edited or deleted before posting. The case description can also be edited or deleted after posting by using the view/modify an existing case 305 function. The modified cases are reposted and reprocessed by the matching system. The matching system may notify prior attorney recipients of the case if modifications have been made to the case or if the case has been deleted.

A problem with the other legal service matching systems is that the consumers do not know what information is necessary to accurately describe their case. These systems utilize require the consumer to write, in their own words, a description the case. Because the consumer typically does not have a legal background, the consumer may not address all issues required to analyze the case. When the case is posted without all required information, the attorneys viewing the post cannot accurately bid on the case. The individual attorneys must then request the missing information from the consumer. The case descriptive questions and answer listings of the inventive service matching system improves the accuracy and simplifies the case description process for consumers.

When a case is posted, the matching system stores the consumer's case description on the consumer database. The matching system then cross references the primary category and location of the consumer with the attorney database. For example, if a case is posted by a consumer who needs legal assistance related to intellectual property, the consumer will answer category and intake questions that describe this type of case. The matching system filters out all attorneys who are not qualified in patent prosecution and forwards a description of the case to the homepages of attorneys whose practice includes patent law and who are located in the same geographic area as the consumer.

The geographic proximity of the attorney and consumer may be determined based upon zip codes, within state or multiple-state. The consumer may choose or the matching system may automatically select a maximum distance between parties. The matching system may calculate approximate distances between attorneys and consumers from the parties' zip codes or states. Alternatively, the matching system may be set to match attorneys and clients from different states. The matching system will not automatically forward the case to attorneys who are located farther than the specified distance. Although, the cases may not be automatically forward cases to all attorney members, the attorneys may be able search through and view all posted cases.

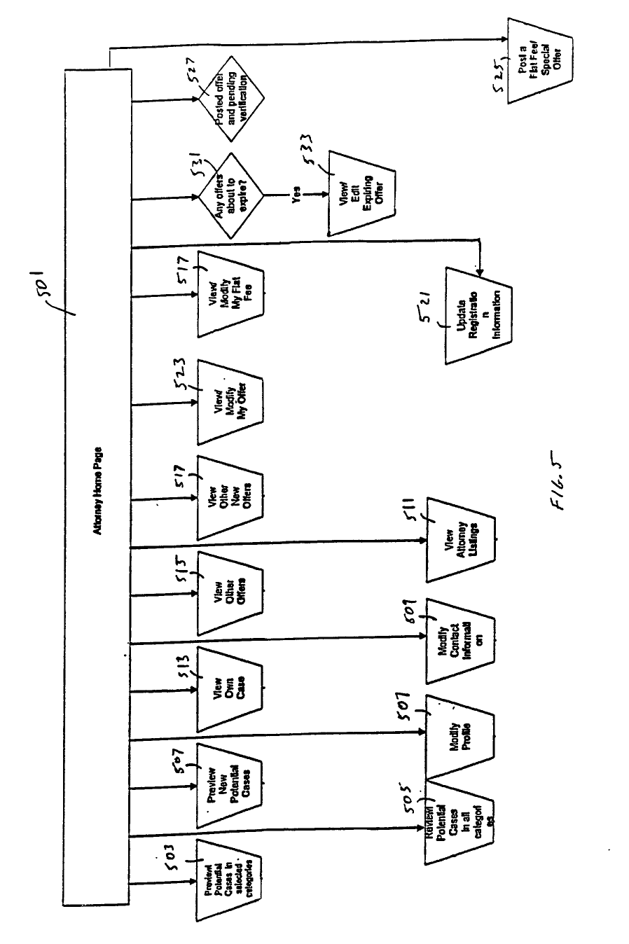

As discussed, each attorney accesses the matching system through his or her own homepage. FIG. 5 illustrates a flowchart of the features accessible through the attorney homepage 501. The preview potential cases 503 function allows the attorney to view cases posted by consumers that are in the attorney's area of practice. These cases are considered to be “potential” because an attorney has not yet been assigned to the case, although the potential case has been forwarded to the attorney by the matching system. The attorney can view all potential cases by selecting preview potential cases in all categories 505. The attorney can view all potential new cases that have been recently posted by selecting preview new potential cases 507.

Information about an attorney may need to be updated periodically to keep business addresses and phone numbers current or to publish updated information about the attorney, such as new state bar licenses or any other new qualifications. The attorney can update the attorney information on the matching system by selecting the modify profile 507 function, the modify contact information 509 function or the update registration information function 521.

As discussed, the attorney can post flat fees or special offers for legal services by selecting the post a flat fee/special offer 525 function. The attorney can also view only recently placed flat fees or special offers from other attorneys by selecting view other new offers 517. The attorney may also revise his or her own flat fees or special offers by selecting view/modify my flat fee/special offer 519. Typically the flat fees or special offers have a limited duration. The matching system determines if any offers are about to expire 531 and allows the attorney to view/edit an expiring offer 533

In an embodiment, after the attorney places offers on a case, the progress of the case can be monitored. The attorney can view offers from other attorneys by selecting view other offers 515. The attorney can also view additional information about other competing attorneys by selecting the view attorney listing 511 function. After the attorney's offer has been accepted by the consumer, the corresponding case is forwarded to the attorney's case section. The attorney can view the accepted cases by selecting own cases 513. The view and modify my offer 523 function allows the attorney to view and modify offers to posted cases.

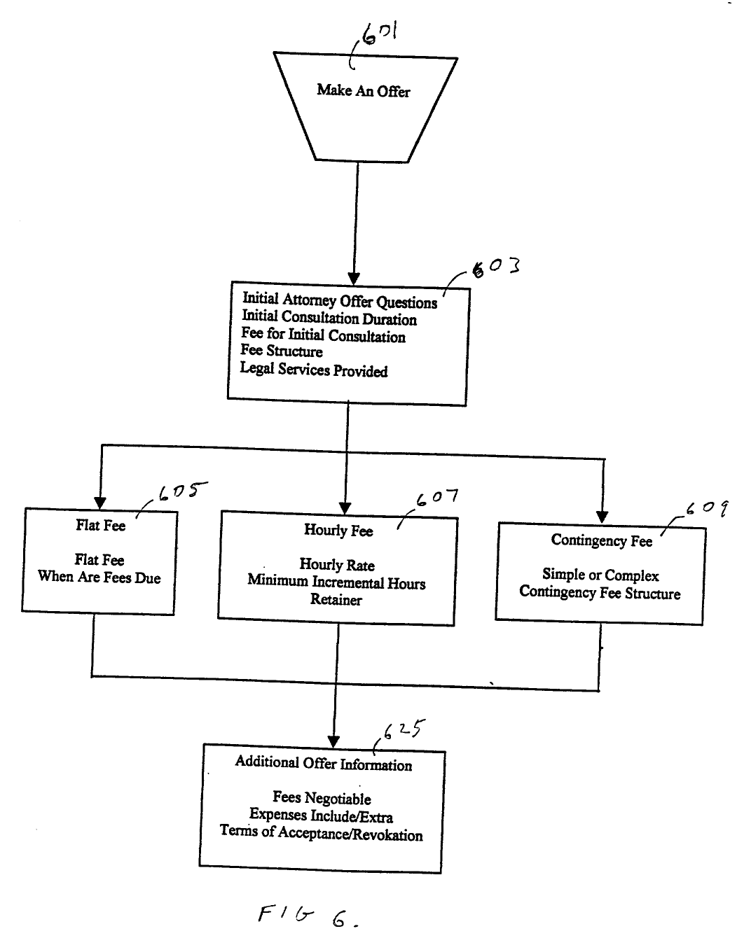

With reference to FIG. 6, the matching system can assist the attorney in creating an offer using the make an offer function 601. Like the client posting function, the matching system asks the attorney a series of questions. The attorney can click on the appropriate answer and the matching system will use this information to create an offer to the consumer's posted case. Typically the offer will include initial questions 603 regarding an initial consultation and fee structure required, a text description of the offer 611 and terms under which the offer can be accepted or revoked 621. Alternatively the attorney can input as much information as desired manually.

The matching system asks the attorney initial questions 603 including:

What is the duration of an initial consultation?

What is the fee (if any) for the initial consultation?

What fee structure is required if the attorney takes the case?

The matching system lists answers for the fee structures that includes: flat fee for services 605, hourly rate 607, and a contingency fee 609. The attorney provides the requested information by clicking of an appropriate answer listed or entering a text response.

In response to the attorney's fee structure preference, the matching system asks the attorney additional questions regarding the fee structure. If a flat fee 605 is required, the matching system asks the attorney when the fees are due and lists the answers: in full when case is taken, in full when work is finished, in part when case is taken and in part when work is finished, due in part when case is taken and remainder in partial installments and partial payments in installments. If the hourly fee 607 is selected, the matching system asks the attorney to input: hourly rate, minimum increment of hourly rate and retainer requirements. If the contingency fee 609 is selected, the matching system asks the attorney if the contingency arrangement will be: a simple fee equal to a percentage of any settlement or judgment or a complex fee. The complex contingency fee may be based upon a first percentage if a settlement is reached before suit filed, a second percentage if a percentage of settlement or judgment after suit is filed, a third percentage of settlement or judgment after trial, etc. After the questions describing the fee structure are answered, the matching system prompts the attorney to enter a text description of the case which may include a recommendation.

The attorney's offer may also include additional information 625 regarding: if the fees are negotiable, what expenses are or are not included in the fees and terms under which the offer can be accepted or revoked. In an embodiment, the flat fees may be negotiable or subject to change based upon further case information. The attorney expenses incurred that may be charged separately may include: filing fees, court costs, travel, telephone and facsimile, copying, postage, and other expenses. The terms under which the offer can be revoked may be any time before the offer is accepted or the offer may remain open for a preselected period of time.

After the attorney has reviewed the bid information for accuracy, the attorney can transmit the bid through the matching system to the consumer. The attorney can view, edit, modify or revoke the bid after it is posted through the view and modify my offer function through the attorney homepage. Typically many attorneys will respond to a case. In an embodiment the attorney may be automatically notified when another attorney has underbid the attorney on a case. The attorney may then modify his or her bid on the case in response to the another attorney's lower bid. Alternatively, the attorney can view bids from other attorneys from the attorney home page.

As discussed, all attorney bids are transmitted back to the homepage of the consumer. The consumer may access all bids through the view offers 309 function discussed with reference to FIG. 3. The matching system allows consumers to compare the bids received and obtain additional information about the attorneys through the consumer homepage. Based upon the information provided by the matching system, the consumer can make an informed decision in selecting an attorney for a case. After the consumer and selected attorney agree upon terms of the legal services, the parties may meet for an initial consultation. Thereafter the attorney may agree to perform legal services for the consumer and the consumer compensates the attorney under the terms of the agreement.

After the consumer has had some experience with the attorney and/or the services have been completed, the consumer can rate the performance of the attorney using the rate an attorney function. This feature allows attorneys to develop a history or professional reputation within the matching system that is available for review by consumers. Consumers can provide feed back regarding the service received using the rate an attorney function. A user can view a listing of attorneys and select a specific attorney name to rate. The matching system asks the user a series of questions related to the rating of the attorney. Like the case posting process, the questions have a listing of preselected answers that the user can click on. The rating questions may include:

What level of contact did the use have with the attorney?

Did the attorney respond in a timely manner?

Did the attorney answer questions clearly?

Were the user needs understood by the attorney?

Did the attorney provide complete and clear information?

Was the attorney knowledgeable in the legal area?

Was the attorney a good value for the money?

Would the user use the attorney again?

Would the user recommend the attorney to a friend?

The listed answers may be simply yes/no or a range such as: poor, fair, good, very good or excellent. The consumer can also add additional text comments to the reviews so that they not limited to the listed answers.

The consumer can edit the answers to the attorney rating questions before submitting the review and in an embodiment, the consumer can edit the review after it is posted. Once the review is submitted, the user's answers to the attorney rating questions are accessible to registered consumers. In an embodiment, the matching system informs the attorney when a rating has been posted for the attorney. After the consumer has posted a rating, the attorney can post comments in response to the consumer review that are attached to the review. These comments can be used to describe the outcome of the case or rebut the consumer's rating. In an embodiment, the matching system will request that the consumer submit a review of an attorney after a preset period of time or after the attorney's work for the consumer is completed.

The attorney ratings may be viewed through the attorney listing. As discussed, the attorney listings can be accessed from the consumer or attorney homepage. The attorney listing can be searched by: name, location, area of practice, or any other database data. After a specific attorney is found information about the attorney can be viewed by: profile, contact information, or rating. The attorney profile includes: professional information, education, and area of practice. The contact information may include: address, office phone number, mobile phone number, fax number and e-mail address.

The matching system provides attorneys with a means for obtaining more clients and revenues. In exchange for the matching system services, attorneys may be charged for use of the matching system. These attorney charges may be on a membership basis and/or on a referral basis. Under a membership plan, a flat fee may be charged for providing the attorney's information on the matching system and unlimited use of the matching system. Under a referral plan, attorneys may be allowed to use the system free of charge or for a nominal fee. The attorneys may be charged listing fees that are proportional to consumer interest generated by the matching system. As discussed, the matching system is capable of tracking consumers and attorneys use of the matching system. In particular the matching system can count the number of times that an attorney's profile or contact information is accessed by consumers. When a consumer views an attorney's profile or contact information, this act typically indicates that a consumer is considering using the attorney for a case. The level of consumer interest can be quantified because the matching system can track the number of times consumers view the attorney's profile and contact information. Under a referral plan, attorney's may be charged a fee each time a consumer views the attorney's profile or contact information.

Because the matching system can track consumers' use of the system, specific levels of consumer exposure can be monitored. For example the matching system may guarantee that at least 20 consumers will view the attorney's profile information per month. The matching system can keep track of the number times a consumer has viewed the attorney's profile information. If the attorney profile is not viewed 20 times within a one month period, special reductions usage fee can be made.

In the foregoing, a system for matching consumers with service providers has been described. Although the present invention has been described in considerable detail with reference to specific exemplary embodiments, it will be evidence that various modifications and changes may be made to these embodiments without departing from the broader spirit and scope of the invention as set forth in the claims. Accordingly, the specification and drawings, which describe the service matching system are to be regarded in an illustrative rather than a restrictive sense.

| Primary Category | Secondary Category | Narrow Category |
|---|---|---|
| Business | Bars and Restaurants | Liquor Liability |
| Business | Bars and Restaurants | Liquor Licensing |
| Business | Commercial Law and | Breach of Contract |
| | Contract | |
| Business | Commercial Law and | Business and Commercial |
| | Contracts | Law |
| Business | Commercial Law and | Consumer Credit |
| | Contracts | |
| Business | Commercial Law and | Covenants Not to Compete |
| | Contracts | |
| Business | Commercial Law and | Employment Contracts |
| | Contracts | |
| Business | Commercial Law and | Franchises and Franchising |
| | Contracts | |
| Business | Commercial Law and | International Commercial |
| | Contracts | Law |
| Business | Commercial Law and | Negotiating, Drafting and |
| | Contracts | Revisions |
| Business | Commercial Law and | Warranties |
| | Contracts | |
| Business | Commercial Law and | Y2K Law |
| | Contracts | |
| Business | Construction | Construction |
| Business | Construction | Construction Accidents |
| Business | Construction | Construction Defects |
| Business | Construction | Dangerous Property or |
| | | Building |
| Business | Construction | Mechanics Liens |
| Business | Corporations, | Business and Commercial |
| | Partnerships | Law |
| Business | Corporations, | Buying and Selling |
| | Partnerships | Business |
| Business | Corporations, | Corporations |
| | Partnerships | |
| Business | Corporations, | Family Businesses |
| | Partnerships | |
| Business | Corporations, | Franchises and Franchising |
| | Partnerships | |
| Business | Corporations, | Limited Liability Companies |
| | Partnerships | |
| Business | Corporations, | Mergers & Acquisitions |
| | Partnerships | |
| Business | Corporations, | Minority Businesses |
| | Partnerships | |
| Business | Corporations, | Nonprofits |
| | Partnerships | |
| Business | Corporations, | Partnerships |
| | Partnerships | |
| Business | Corporations, | Professional Practices |
| | Partnerships | |
| Business | Corporations, | Small Businesses |
| | Partnerships | |
| Business | Corporations, | Annuities |
| | Partnerships | |
| Business | Insurance | Automobile Insurance |
| Business | Insurance | Bad Faith |
| Business | Insurance | Commercial Insurance |
| Business | Insurance | Health Insurance |
| Business | Insurance | Life Insurance |
| Business | Insurance | Professional (Malpractice) |
| | | Ins |
| Business | Insurance | Property Insurance |
| Business | Other | Communication and Media |
| Business | Other | Cyberspace Law |
| Business | Other | Entertainment Law |
| Business | Other | Gaming Law |
| Business | Other | Sports Law |
| Business | Tax | Corporate Tax |
| Business | Tax | Estate and Gift Tax |
| Business | Tax | Income Tax |
| Business | Tax | International Tax |
| Business | Tax | Property Tax |
| Business | Tax | Tax Evasion |
| Business | Unfair Competition | Antitrust and Trade |
| | | Regulation |
| Business | Unfair Competition | False Advertising |
| Business | Unfair Competition | Unfair Competition |
| Criminal Law | Automobile | Driving While Intoxicated |
| and Police | | |
| Criminal Law | Automobile | Traffic Violations |
| and Police | | |
| Criminal Law | General/Other | Criminal Law |
| and Police | | |
| Criminal Law | General/Other | Drug Crimes |
| and Police | | |
| Criminal Law | General/Other | Felonies |
| and Police | | |
| Criminal Law | General/Other | Misdemeanors |
| and Police | | |
| Criminal Law | General/Other | Parole and Probation |
| and Police | | |
| Criminal Law | General/Other | Right to Bear Arms |
| and Police | | |
| Criminal Law | Juveniles | Juvenile Crime or Detention |
| and Police | | |
| Criminal Law | Personal Crimes | Assault and Battery |
| and Police | | |
| Criminal Law | Personal Crimes | Homicide |
| and Police | | |
| Criminal Law | Personal Crimes | Sexual Assault |
| and Police | | |
| Criminal Law | Police and Prosecutors | Governmental Discrimination |
| and Police | | |
| Criminal Law | Police and Prosecutors | Police Misconduct |
| and Police | | |
| Criminal Law | Property Crimes | Environmental Crimes |
| and Police | | |
| Criminal Law | Property Crimes | Theft |
| and Police | | |
| Criminal Law | Property Crimes | Vandalism |
| and Police | | |
| Criminal Law | White Collar Crime | Criminal Fraud |
| and Police | | |
| Criminal Law | White Collar Crime | Embezzlement |
| and Police | | |
| Criminal Law | White Collar Crime | Insider Trading |
| and Police | | |
| Criminal Law | White Collar Crime | RICO |
| and Police | | |
| Criminal Law | White Collar Crime | Securities Fraud |
| and Police | | |
| Criminal Law | White Collar Crime | Tax Evasion |
| and Police | | |
| Criminal Law | White Collar Crime | Trade Secrets |
| and Police | | |
| Criminal Law | White Collar Crime | White Collar Crime |
| and Police | | |
| Family | Animals | Animal Law |
| Family | Animals | Animal Rights |
| Family | Animals | Dog Bites/Animal Attacks |
| Family | Children | Adoptions |
| Family | Children | Child Abuse |
| Family | Children | Child Custody and Visitation |
| Family | Children | Child Support |
| Family | Children | Education Law |
| Family | Children | Guardianship |
| Family | Children | Juvenile Crime or Detention |
| Family | Children | Sexual Abuse |
| Family | Children | Surrogates |
| Family | General/Other | Family Law |
| Family | General/Other | Restraining Orders |
| Family | Husband or Wife | Alimony/Spousal Support |
| Family | Husband or Wife | Divorce/Annulment |
| Family | Husband or Wife | Domestic Violence |
| Family | Husband or Wife | Enforcement of Decrees |
| Family | Husband or Wife | Prenuptial Agreements |
| Family | Husband or Wife | Separations |
| Family | Parents | Age Discrimination |
| Family | Parents | Elder Care |
| Family | Parents | Elder Law |
| Family | Parents | Enforcement of Decrees |
| Family | Parents | Medicare/Medicaid |
| Family | Parents | Nursing Homes |
| Family | Parents | Social Security |
| Finances | Banking | Commercial Banking |
| Finances | Banking | Consumer Banking |
| Finances | Banking | Consumer Credit |
| Finances | Banking | Foreclosures |
| Finances | Banking | Lender Discrimination |
| Finances | Banking | Mortgages |
| Finances | Bankruptcy | Commercial Bankruptcy |
| Finances | Bankruptcy | Consumer Bankruptcy |
| Finances | Credit | Breach of Contract |
| Finances | Credit | Collections |
| Finances | Credit | Consumer Credit |
| Finances | Credit | Consumer Protection/Fraud |
| Finances | Credit | Creditors' Rights |
| Finances | Credit | Debtors' Rights |
| Finances | Credit | Repossessions |
| Finances | Insurance | Annuities |
| Finances | Insurance | Automobile Insurance |
| Finances | Insurance | Bad Faith |
| Finances | Insurance | Commercial Insurance |
| Finances | Insurance | Health Insurance |
| Finances | Insurance | Life Insurance |
| Finances | Insurance | Professional (Malpractice) |
| | | Ins |
| Finances | Insurance | Property Insurance |
| Finances | Investments | Annuities |
| Finances | Investments | Income Tax |
| Finances | Investments | Investments |
| Finances | Investments | Securities Fraud |
| Finances | Investments | Securities Law |
| Finances | Other | Gaming Law |
| Finances | Taxes | Corporate Tax |
| Finances | Taxes | Estate and Gift Tax |
| Finances | Taxes | Income Tax |
| Finances | Taxes | International Tax |
| Finances | Taxes | Property Tax |
| Finances | Taxes | Tax Evasion |
| Finances | Wills, trusts and | Charitable Giving |
| | estates | |
| Finances | Wills, trusts and | Contested Wills/Probate |
| | estates | |
| Finances | Wills, trusts and | Drafting Wills and Trusts |
| | estates | |
| Finances | Wills, trusts and | Estate Planning |
| | estates | |
| Finances | Wills, trusts and | Estate and Gift Tax |
| | estates | |
| Finances | Wills, trusts and | Guardianship |
| | estates | |
| Government | Constitutional Law | Constitutional Law |
| Government | Constitutional Law | Free Speech/Press |
| Government | Constitutional Law | Right to Bear Anns |
| Government | Environmental | Environmental Cleanup |
| Government | Environmental | Environmental Permitting |
| Government | Environmental | Wetlands |
| Government | Other | Administrative Law |
| Government | Other | Government Agencies and |
| | | Programs |
| Government | Other | Government Contracts |
| Government | Other | Governmental Discrimination |
| Government | Other | Indian/Native American Law |
| Government | Other | International Human Rights |
| Government | Other | Liquor Licensing |
| Government | Other | Social Security |
| Government | Other | Voting Rights |
| Government | Other | Zoning, Planning and Land |
| | | Use |
| Government | Taxes | Corporate Tax |
| Government | Taxes | Estate and Gift Tax |
| Government | Taxes | Income Tax |
| Government | Taxes | International Tax |
| Government | Taxes | Property Tax |
| Government | Taxes | Tax Evasion |
| Health or Injury | Health Care and | Elder Care |
| | Insurance | |
| Health or Injury | Health Care and | Health Care |
| | Insurance | |
| Health or Injury | Health Care and | Health Insurance |
| | Insurance | |
| Health or Injury | Health Care and | Long Term Care |
| | Insurance | |
| Health or Injury | Health Care and | Medicare/Medicaid |
| | Insurance | |
| Health or Injury | Health Care and | Nursing Homes |
| | Insurance | |
| Health or Injury | Injury Accidents | Airplane Crashes |
| Health or Injury | Injury Accidents | Automobile Accidents |
| Health or Injury | Injury Accidents | Construction Accidents |
| Health or Injury | Injury Accidents | Liquor Liability |
| Health or Injury | Injury Accidents | Personal Injury |
| Health or Injury | Injury Accidents | Railroad Accidents |
| Health or Injury | Intentional Injuries | Assault and Battery |
| Health or Injury | Injury Accidents | Dangerous Products |
| Health or Injury | Injury Accidents | Dangerous Property or |
| | | Building |
| Health or Injury | Injury Accidents | Dog Bites/Animal Attacks |
| Health or Injury | Injury Accidents | Domestic Violence |
| Health or Injury | Injury Accidents | Emotional Distress |
| Health or Injury | Injury Accidents | Police Misconduct |
| Health or Injury | Injury Accidents | Sexual Abuse |
| Health or Injury | Injury Accidents | Wrongful Death |
| Health or Injury | Medical Malpractice | Medical Malpractice |
| Immigration | Visas, Citizenship, | Citizenship |
| | Deportation | |
| Immigration | Visas, Citizenship, | Deportation |
| | Deportation | |
| Immigration | Visas, Citizenship, | Immigration |
| | Deportation | |
| Immigration | Visas, Citizenship, | International Human Rights |
| | Deportation | |
| Immigration | Visas, Citizenship, | Political Asylum |
| | Deportation | |
| Immigration | Visas, Citizenship, | Visas |
| | Deportation | |
| Intellectual | Patents, Copyrights, | Copyright |
| Property | Trademark | |
| Intellectual | Patents, Copyrights, | Covenants Not to Compete |
| Property | Trademark | |
| Intellectual | Patents, Copyrights, | Intellectual Property |
| Property | Trademark | |
| Intellectual | Patents, Copyrights, | Patents |
| Property | Trademark | |
| Intellectual | Patents, Copyrights, | Trade Secrets |
| Property | Trademark | |
| Intellectual | Patents, Copyrights, | Trademarks |
| Property | Trademark | |
| Job or | Discrimination and | Age Discrimination |
| Employment | Harassment | |
| Job or | Discrimination and | Disabilities |
| Employment | Harassment | |
| Job or | Discrimination and | Employment Discrimination |
| Employment | Harassment | |
| Job or | Discrimination and | Gay and Lesbian Rights |
| Employment | Harassment | |
| Job or | Discrimination and | Language Discrimination |
| Employment | Harassment | |
| Job or | Discrimination and | Race or Nationality |
| Employment | Harassment | Discrimination |
| Job or | Discrimination and | Sexual Harassment |
| Employment | Harassment | |
| Job or | Discrimination and | Women's Rights |
| Employment | Harassment | |
| Job or | Employment Contracts | Employment Contracts |
| Employment | | |
| Job or | Employment Contracts | Trade Secrets |
| Employment | | |
| Job or | Injuries | Personal Injury |
| Employment | | |
| Job or | Injuries | Workers' Compensation |
| Employment | | |
| Job or | Pay and Benefits | Family and Medical Leave |
| Employment | | |
| Job or | Pay and Benefits | Pensions and Benefits |
| Employment | | |
| Job or | Pay and Benefits | Wage and Hour/Overtime Pay |
| Employment | | |
| Job or | Pay and Benefits | Workers' Compensation |
| Employment | | |
| Job or | Unions | Labor Law |
| Employment | | |
| Job or | Wrongful Termination | Workplace Disputes |
| Employment | | |
| Job or | Wrongful Termination | Wrongful Termination |
| Employment | | |
| Lawsuits | Litigation, Mediation, | Alternative Dispute |
| | Arbitration | Resolution |
| Lawsuits | Litigation, Mediation, | Arbitration |
| | Arbitration | |
| Lawsuits | Litigation, Mediation, | Litigation and Appeals |
| | Arbitration | |
| Lawsuits | Litigation, Mediation, | Mediation |
| | Arbitration | |
| Products and | Automobiles | Automobile Accidents |
| Services | | |
| Products and | Automobiles | Automobile Insurance |
| Services | | |
| Products and | Automobiles | Automotive Products |
| Services | | |
| Products and | Automobiles | Consumer Credit |
| Services | | |
| Products and | Automobiles | Driving While Intoxicated |
| Services | | |
| Products and | Automobiles | Lemon Law |
| Services | | |
| Products and | Automobiles | Traffic Violations |
| Services | | |
| Products and | Boats | Admiralty/Maritime Law |
| Services | | |
| Products and | Credit | Collections |
| Services | | |
| Products and | Credit | Consumer Credit |
| Services | | |
| Products and | Credit | Consumer Protection/Fraud |
| Services | | |
| Products and | Credit | Creditors' Rights |
| Services | | |
| Products and | Credit | Debtors' Rights |
| Services | | |
| Products and | Credit | Repossessions |
| Services | | |
| Products and | Credit | Warranties |
| Services | | |
| Products and | Faulty or Dangerous | Automotive Products |
| Services | Products | |
| Products and | Faulty or Dangerous | Dangerous Products |
| Services | Products | |
| Products and | Faulty or Dangerous | Drugs and Medical Devices |
| Services | Products | |
| Products and | Faulty or Dangerous | Lemon Law |
| Services | Products | |
| Products and | Faulty or Dangerous | Product Liability and |
| Services | Products | Replacement |
| Products and | Faulty or Dangerous | Warranties |
| Services | Products | |
| Products and | Faulty or Dangerous | Y2K Law |
| Services | Products | |
| Products and | Malpractice | Malpractice |
| Services | | |
| Products and | Malpractice | Medical Malpractice |
| Services | | |
| Products and | Malpractice | Professional Responsibility |
| Services | | |
| Real Property and | Commercial Real | Commercial Banking |
| Housin | Estate | |
| Real Property and | Commercial Real | Commercial Real Estate |
| Housin | Estate | |
| Real Property and | Construction | Construction |
| Housin | | |
| Real Property and | Construction | Construction Accidents |
| Housin | | |
| Real Property and | Construction | Construction Defects |
| Housin | | |
| Real Property and | Construction | Dangerous Property or |
| Housin | | Building |
| Real Property and | Construction | Mechanics Liens |
| Housin | | |
| Real Property and | Environmental | Environmental Cleanup |
| Housin | Regulation | |
| Real Property and | Environmental | Environmental Law |
| Housin | Regulation | |
| Real Property and | Environmental | Environmental Permitting |
| Housin | Regulation | |
| Real Property and | Environmental | Wetlands |
| Housin | Regulation | |
| Real Property and | Environmental | Zoning, Planning and Land |
| Housin | Regulation | Use |
| Real Property and | Farm | Agricultural Law |
| Housin | | |
| Real Property and | Farm | Crop Damage |
| Housin | | |
| Real Property and | Farm | Farm and Ranch |
| Housin | | |
| Real Property and | Farm | Livestock |
| Housin | | |
| Real Property and | Financing and Tax | Foreclosures |
| Housin | | |
| Real Property and | Financing and Tax | Mortgages |
| Housin | | |
| Real Property and | Financing and Tax | Property Tax |
| Housin | | |
| Real Property and | General/Other | Dangerous Property or |
| Housin | | Building |
| Real Property and | General/Other | Eminent Domain/ |
| Housin | | Condemnation |
| Real Property and | General/Other | Real Estate/Property Law |
| Housin | | |
| Real Property and | General/Other | Title and Boundary Disputes |
| Housin | | |
| Real Property and | General/Other | Zoning, Planning and Land |
| Housin | | Use |
| Real Property and | House or | Condominiums and |
| Housin | Condominium | Cooperatives |
| Real Property and | House or | Eminent Domain/ |
| Housin | Condominium | Condemnation |
| Real Property and | House or | Housing Discrimination |
| Housin | Condominium | |
| Real Property and | House or | Purchase and Sale of |
| Housin | Condominium | Residence |
| Real Property and | Landlord/Tenant | Dangerous Property or |
| Housin | | Building |
| Real Property and | Landlord/Tenant | Housing Discrimination |
| Housin | | |
| Real Property and | Landlord/Tenant | Landlord / Tenant |
| Housin | | |
| Real Property and | Oil, Gas & Natural | Natural Resources |
| Housin | Resources | |
| Real Property and | Oil, Gas & Natural | Oil & Gas |
| Housin | Resources | |
| Real Property and | Oil, Gas & Natural | Water |
| Housin | Resources | |

What is claimed is:

1. A method of matching service providers with consumers comprising the steps of:
providing a server computer having a memory, and a database of service providers, in communication with a computer network;
providing a consumer computer in communication with the computer network;
providing a consumer user interface to the consumer computer,
asking the consumer a series of questions describing a service need through the user interface;
cross referencing the consumer's answers with a database of service providers to determine the service providers that provide the service need;
providing a service provider computer;
providing a service provider interface to the service provider computer; and
transmitting consumer information to attorney computers in communication with the computer network associated with the service providers that provide the service need.

2. The method of matching service providers with consumers of claim 1 wherein the method further comprises the steps of:
transmitting service provider information to the consumer computer.

3. The method of matching service providers with consumers of claim 2 wherein the service provider information includes a bid to perform the service need.

4. The method of matching service providers with consumers of claim 3 further comprises the steps of:
transmitting acceptance or rejection of the bid to the service provider computer.

5. The method of matching service providers with consumers of claim 1 wherein the consumer information includes a description of the service need and location of the consumer.

6. The method of matching service providers with consumers of claim 1 wherein the consumer interface allows the consumer information to be modified and retransmitted to the service provider computer.

7. The method of method of matching service providers with consumers of claim 2 wherein the service provider interface allows the service provider information to be modifies and retransmitted to the consumer computer.

8. A system for matching an attorney with a consumer comprising:
a network;
a server having a memory, a database of attorney information, and a database of consumer information, in communication with the network;
a consumer computer with a user interface, wherein the server asks the consumer a series of questions related to requested legal services through the user interface,
a matching program that cross references answers from the consumer with the database of attorney information and transmits consumer information to attorneys who provide legal services corresponding to the requested legal services.

9. The system for matching attorneys and consumers of claim 8 wherein the matching program transmits reply information from the attorney computer to the user interface of the consumer computer.

10. The method of controlling or monitoring the first device of claim 9 wherein the reply information includes a bid from the attorney for the legal services.

11. The method of controlling or monitoring the first device of claim 10 wherein the matching system transmits acceptance or rejection of the bid to the service provider computer.

12. The method of controlling or monitoring the first device of claim 8; wherein the consumer information includes a description of the legal services and location of the consumer.

13. The method of matching service providers with consumers of claim 8 wherein the consumer interface allows the consumer information to be modified and retransmitted to the attorney computer.

14. The method of matching service providers with consumers of claim 9 wherein the attorney interface allows the reply information to be modified and retransmitted to the consumer computer.

15. The method of matching attorneys with consumers comprising the steps of:
providing a server computer having a database of consumers and a database of attorneys, in communication with a computer network;
providing a consumer computer in communication with the computer network;
providing a consumer user interface to the consumer computer,
asking the consumer a series of questions describing a service need through the user interface;
storing responses to the series of questions on the consumer database;
cross referencing the consumer's answers with a database of service providers to determine the service providers that provide the service need;
providing a service provider computer;
providing a service provider interface to the service provider computer;
transmitting consumer information to attorney computers in communication with the computer network associated with the service providers that provide the service need; and
transmitting a bid from the attorney computer to the consumer computer.

16. The method of matching attorneys with consumers of claim 15; wherein the method further comprises the step of:
transmitting acceptance of the bid, rejection of the bid or a request for more information to the attorney computer.

17. The method of matching attorneys with consumers of claim 15; wherein the method further comprises the step of:
displaying a plurality of bids from a plurality of attorneys on the consumer user interface.

18. The method of matching attorneys with consumers of claim 17; wherein the method further comprises the step of:
transmitting an acceptance of a bid to one attorney computer; and
transmitting a rejection of bids to all other attorney computers.

19. The method of matching attorneys with consumers of claim 17; wherein the method further comprises the step of:
displaying additional information about the attorney including: education, contact information and areas of practice through the consumer user interface.

20. The method of matching attorneys with consumers of claim 17; wherein the method further comprises the step of:
asking the consumer to review the attorney's service after a preset period of time.
